(19) United States
(12) Patent Application Publication
(10) Pub. No.: US 2026/0039746 A1
(43) Pub. Date: Feb. 5, 2026

(54) INTELLIGENTLY VERIFYING TELEPHONE CALLS USING AUTHENTICATED IDENTITY INFORMATION

(71) Applicant: Numeracle, Inc., McLean, VA (US)

(72) Inventor: Pierce Gorman, Lee's Summit, MO (US)

(73) Assignee: Numeracle, Inc., McLean, VA (US)

(21) Appl. No.: 18/791,617

(22) Filed: Aug. 1, 2024

(51) Int. Cl. H04M 3/436; H04L 65/1069; H04L 65/1104; H04M 3/22; H04M 3/42

(52) U.S. Cl. CPC H04M 3/4365; H04M 3/2281; H04M 3/42076; H04L 65/1069; H04L 65/1104

(57) ABSTRACT

Telephone calls can be automatically verified by a telecommunication system using identity information about the caller. For example, a telecommunication system can receive a communication associated with a caller requesting to make a telephone call to a recipient. The communication can include a reference to a security certificate. The telecommunication system can access the security certificate, the security certificate having a public key and a document identifier. The telecommunication system can retrieve identity information from a storage location using the document identifier. In response to verifying the identity information using the public key, the telecommunication system can flag the caller as verified.

### TECHNICAL FIELD

The present disclosure relates generally to automatically verifying telephone calls. More specifically, but not by way of limitation, this disclosure relates to intelligently and automatically verifying telephone calls using authenticated identity information.

### BACKGROUND

The volume of automated telephone calls (“robocalls”) has recently skyrocketed, with billions of robocalls being made each month. Although telecommunication carriers and regulators appreciate the magnitude of the problem, their attempts to curb robocalls have had little success. The lack of success is in large part due to how a telephone call propagates through a maze of carriers and networks before reaching the recipient, making it difficult to pinpoint the telephone call's origins and enabling the caller to evade regulation.

### SUMMARY

One example of the present disclosure includes a system with one or more processors. The system also includes one or more memories including instructions executable by the one or more processors. The instructions can cause the processor to receive a communication associated with a caller requesting to make a telephone call to a recipient, where the communication includes a reference to a security certificate. The instructions can also cause the processor to access the security certificate via the reference, where the security certificate includes a public key and a document identifier. The instructions can also cause the processor to retrieve identity information from a storage location using the document identifier. The instructions can also cause the processor, in response to verifying the identity information using the public key, to flag the caller as verified.

Another example of the present disclosure includes a method involving receiving, by a telecommunication system, a communication associated with a caller requesting to make a telephone call to a recipient, where the communication includes a reference to a security certificate. The method can also involve accessing, by the telecommunication system, the security certificate via the reference, where the security certificate includes a public key and a document identifier. The method can also involve retrieving, by the telecommunication system, identity information from a storage location using the document. In response to verifying the identity information using the public key, the method can also involve, flagging, by the telecommunication system, the caller as verified.

Still another example of the present disclosure includes a telecommunication system with at least one processor and at least one memory including instructions executable by the at least one processor. The instructions can cause the processor to receive a communication associated with a caller requesting to make a telephone call to a recipient, where the communication includes a reference to a security certificate. The instructions can also cause the processor to access the security certificate via the reference, where the security certificate includes a public key and a document identifier. The instructions can also cause the processor to retrieve identity information from a storage location using the document identifier. In response to a verification process failing for the identity information, the instructions can cause the processor to flag the caller as not verified. In one example, in response to flagging the caller as not verified, the instructions can cause the processor to block the telephone call.

Yet another example of the present disclosure includes a method involving receiving, by a telecommunication system, a communication associated with a caller requesting to make a telephone call to a recipient, where the communication includes a reference to a security certificate. The method can also involve accessing, by the telecommunication system, the security certificate via the reference, where the security certificate includes a public key and a document identifier. The method can also involve retrieving, by the telecommunication system, identity information from a storage location using the document. In response to a verification process failing for the identity information, the method can also involve flagging, by the telecommunication system, the caller as not verified. In some examples, in response to flagging the caller as not verified, the method can involve blocking the telephone call.

Another example of the present disclosure includes a non-transitory computer-readable medium comprising program code that is executable by a processor to cause the processor to: receive a communication associated with a caller requesting to make a telephone call to a recipient, the communication including a reference to a security certificate; access the security certificate via the reference, the security certificate including a public key and a document identifier; retrieve identity information from a storage location using the document identifier; and in response to verifying the identity information using the public key, flag the caller as verified.

Another example of the present disclosure includes a non-transitory computer-readable medium comprising program code that is executable by a processor to cause the processor to: receive a communication associated with a caller requesting to make a telephone call to a recipient, the communication including a reference to a security certificate; access the security certificate via the reference, the security certificate including a public key and a document identifier; retrieve identity information from a storage location using the document identifier; and in response to a verification process failing for the identity information, flag the caller as not verified. In some examples, in response to flagging the caller as not verified, the program code can cause the processor to block the telephone call.

Various other examples are described herein, including methods, systems, non-transitory computer-readable storage media storing programs, code, or instructions executable by one or more processors and the like. These illustrative examples are mentioned not to limit or define the scope of this disclosure, but rather to provide examples to aid understanding thereof. Illustrative examples are discussed in the Detailed Description, which provides further description. Advantages offered by various examples may be further understood by examining this specification.

### BRIEF DESCRIPTION OF THE DRAWINGS

FIG. 1 is a block diagram of an example network environment suitable for intelligently verifying telephone calls using authenticated identity information according to some aspects.

FIG. 2 is a flow diagram of an example of a process for intelligently verifying telephone calls using authenticated identity information according to some aspects.

FIG. 3 is a block diagram of an example of a process for issuing identity information according to some aspects.

FIG. 4 is a block diagram of an example of a process for establishing an inter public key infrastructure (PKI) trust relationship for intelligently verifying telephone calls using authenticated identity information according to some aspects.

FIG. 5 is a flowchart of an example of a process for intelligently verifying telephone calls using authenticated identity information according to some aspects.

FIG. 6 is a block diagram of an example of a computing system usable to implement some aspects.

### DETAILED DESCRIPTION

Reference will now be made in detail to various and alternative illustrative examples and to the accompanying drawings. Each example is provided by way of explanation and not as a limitation. It will be apparent to those skilled in the art that modifications and variations may be made. For instance, features illustrated or described as part of one example may be used in another example to yield a still further example. Thus, it is intended that this disclosure includes modifications and variations as come within the scope of the appended claims and their equivalents.

As used herein, the terms “a,” “an,” and “the” can refer to one or more unless specifically noted otherwise. And the term “or” is not to be construed as identifying mutually exclusive options. For example, the phrase “X contains A or B” can mean that X contains A and not B, X contains B and not A, or X contains both A and B. That is, the term “or” is used to mean “and/or” unless explicitly indicated to refer to alternatives only or the alternatives are mutually exclusive.

### Illustrative Example of Intelligently Verifying Telephone Calls Using Authenticated Identity Information

One illustrative example of the present disclosure includes a telecommunication system that transmits a call request from a caller to a recipient. The call request is initiated by the caller and includes various information about the telephone call that can be used by the telecommunication system to verify the identity of the caller. The call request includes the caller's telephone number, the recipient's telephone number, the time of the telephone call, and a reason for the call. This information is packaged into a JavaScript Object Notation (JSON) web token and transmitted in a session initiation protocol (SIP) method as part of the call request, where the SIP method is an invitation from the caller inviting the recipient to start a session (e.g., talk on the phone) using a voice over internet (VOIP) protocol. Additionally, the JSON web token includes a cryptographic signature and a reference to a security certificate, which includes a public key and additional information about the caller. Examples of the reference can include a uniform resource identifier, an IP address, or a unique name of the security certificate. The SIP method is then received by the telecommunication system.

The telecommunication system can extract the reference to the security certificate from the SIP method and use the reference to access the security certificate. The telecommunication system can then extract the additional information about the caller from the security certificate. Examples of the additional information can include a country, organization, organizational unit, distinguished name qualifier, state or province name, common name, serial number, locality, title, surname, given name, initials, pseudonym, and/or generation qualifier (e.g., “Jr.,” “3rd,” or “IV”) associated with the caller.

One mechanism of verifying the caller's identity uses Secure Telephone Identity Revisited (STIR) and Signature-based Handling of Asserted Information Using toKENS (SHAKEN) technology, which utilizes public/private key asymmetric cryptography where a private key composed of numeric content is used as an input into a cryptographic signature algorithm. As noted above, the public key, also numeric, is published in the security certificate. The public key is used by digital signature verification software implemented by the telecommunication system to verify digital signatures proving authenticity of calling and called numbers.

To further improve the authentication and verifiability of the telephone call, a third source of identity information is included in the communication received by the telecommunication system. In particular, the security certificate also includes an extension containing a second reference pointing to a storage location. This second reference, which may be a uniform resource identifier such as a Uniform Resource Name (URN), for example, points the telecommunication system to a storage location that can be a blockchain, a distributed ledger, or a database configured to store identity information about entities, such as the caller.

The identity information stored in the storage location contains additional identity information about the caller that is not able to be included in the SIP method or security certificate. One such example of identity information included in the storage location can be insurance information about the caller. Other examples are provided herein. Additionally, the identity information stored in the storage location is verified by the telecommunication by checking that the identity information has a cryptographic signature able to be verified using the public key contained in the security certificate. Thus, the identity information in the SIP method and the identity information in the storage location are both verified using the public key found in the security certificate, thereby enabling the telecommunication system to ensure that all such information is related to the same entity.

After verifying the caller identity using the various sources of information (e.g., SIP method, security certificate, and identity information), the telecommunication system transmits the telephone call to the recipient with an indication that the caller is verified. The telecommunication system may also include the identity information from one or more of the sources in the transmission of the telephone call to the recipient, thereby providing the recipient with additional information about the caller. Alternatively, and in the case where the telecommunication system is not able to verify the identity information, the telecommunication system transmits the telephone call to the recipient with an indication that the caller is not verified. This may indicate to the recipient that the telephone call is spam, fraud, or another undesirable type of call.

Numerous benefits are achieved by way of the present disclosure over conventional techniques for automated caller verification. By utilizing a combination of sources of identity information to validate the caller, a more robust verification process is achieved than conventional verification technologies. This can help curb the amount of robocalls, spam, and fraud received by call recipients. Also, this additional identity information can be passed on to the recipients of the telephone calls, so that they can better evaluate and verify caller identity on their end. Another benefit can flow from using an extension included in the security certificate to reference an external storage location, which contains additional identity information. Since such additional identity information cannot be directly included in the security certificate itself, conventionally such identity information is excluded from the evaluation process. But some examples can allow for the use of such information, so that telephone calls can be more accurately verified by using more information associated with callers. For example, the external storage location could include identity information about the caller such as licensing information, insurance information, enterprise information, and the like-all of which are not possible to include in telephone calls using conventional techniques. But some examples described herein can allow for such additional identity information to be included in the evaluation process. Additionally, the techniques described by the present disclosure can be easily integrated into the pre-existing authentication techniques (e.g., STIR/SHAKEN) currently used by telecommunication systems, thereby enabling efficient implementation without large changes to existing telecommunications infrastructure.

The description of the illustrative example above is provided merely as an example, not to limit or define the limits of the present subject matter. Various other examples are described herein and variations of such examples would be understood by one of skill in the art. Advantages provided by various examples may be further understood by examining this specification and/or by practicing one or more examples of the claimed subject matter.

### Illustrative Systems and Methods for Intelligently Verifying Telephone Calls Using Authenticated Identity Information

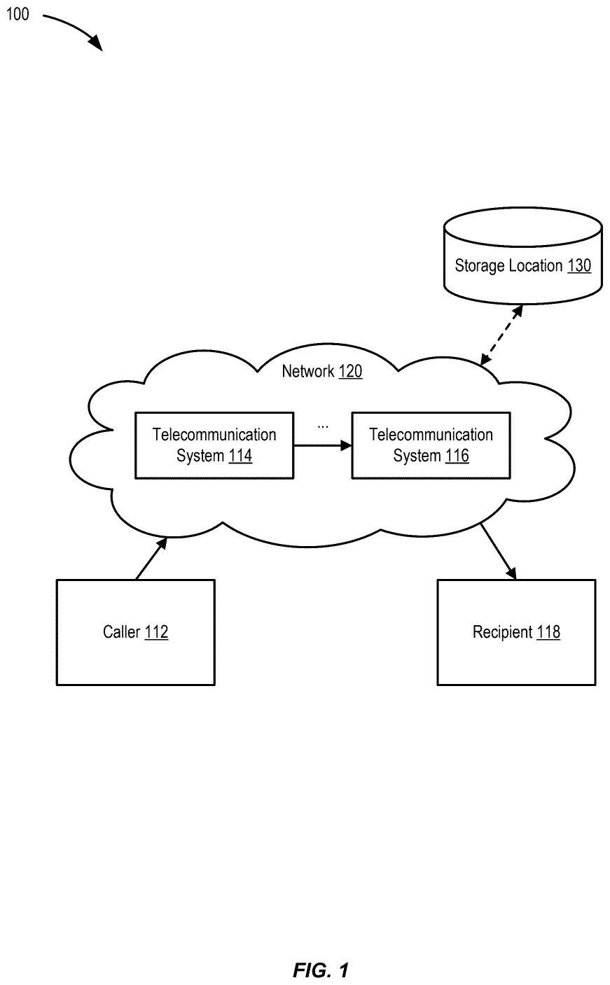

Turning now to the figures, FIG. 1 is a block diagram of an example network environment 100 suitable for intelligently verifying telephone calls using authenticated identity information according to some aspects. As shown in FIG. 1, network environment 100 includes a caller 112 and a recipient 118. The term “caller” may refer to a calling entity and/or their user equipment, such as their mobile phone or other telephonic device, used to initiate a telephone call. Similarly, the term “recipient” may refer to any called entity and/or their user equipment, such as their mobile phone or other telephonic device, used to receive a telephone call.

Also included in the network environment 100 is telecommunication system 114 and telecommunication system 116 hosted on network 120. As a telephone call traverses through the voice telecommunications network from a caller 112 to a recipient 118, the telephone call may “hop” to numerous different telecommunication systems along a call route as it is transmitted to its end destination. Although only two telecommunication systems are illustrated by FIG. 1, the network environment 100 can include any number of telecommunication systems, where each of these telecommunication systems can be conceptually positioned between telecommunication system 114 and telecommunication 116, such that the call request is transmitted starting at telecommunication system 114, hops to one or more intermediate telecommunication service providers, and is received by telecommunication system 116, where it can then be transmitted to the recipient 118. Additionally, each telecommunication system that is positioned along the call route can correspond to a telecommunication service provider and house the physical infrastructure for routing telephone calls between callers and recipients. For example, the telecommunication systems 114 and 116 can coupled together via network 120 and each telecommunication system can be public switched telephone networks (PSTN) and/or have respective base stations, switches, local exchanges, and core networks for transmitting telephone calls between callers and recipients.

In some examples, telecommunication system 114 can be referred to as an originating telecommunication service provider and telecommunication system 116 can be referred to as a terminating telecommunication service provider. An originating telecommunication service provider can be responsible for receiving call requests from their customers and transmitting them along a call route to the intended recipient. The originating telephone service provider can be the first telecommunication service provider in the chain of telecommunication service providers along the end-to-end call path. Similarly, the terminating telecommunication service provider can be the final telecommunication service provider in the chain of telecommunication service providers along the end-to-end call path. The terminating telecommunication service provider can be responsible for transmitting the call request to the intended recipient.

Also included in network environment 100 can be a storage location 130. Storage location 130 can be communicatively coupled to network 120 such that the telecommunication service providers 114 and 116 can access the storage location 130. Storage location 130 can be any suitable storage location configured to store, publish, or otherwise make available identity information associated with a caller 112. For example, storage location 130 can be a blockchain (public or private), a registry (centralized or decentralized), or a data repository. In the case of a blockchain, storage location 130 includes a series of sequential, immutable entries referred to as “blocks.” Each block is distinct from the block before it but linked to the prior block via a hashed pointer, thereby creating a sequential chain of blocks or “blockchain.” The blockchain can serve as a trusted record that can be relied on by the telecommunication systems 114 and 116 to verify identity information associated with caller 112.

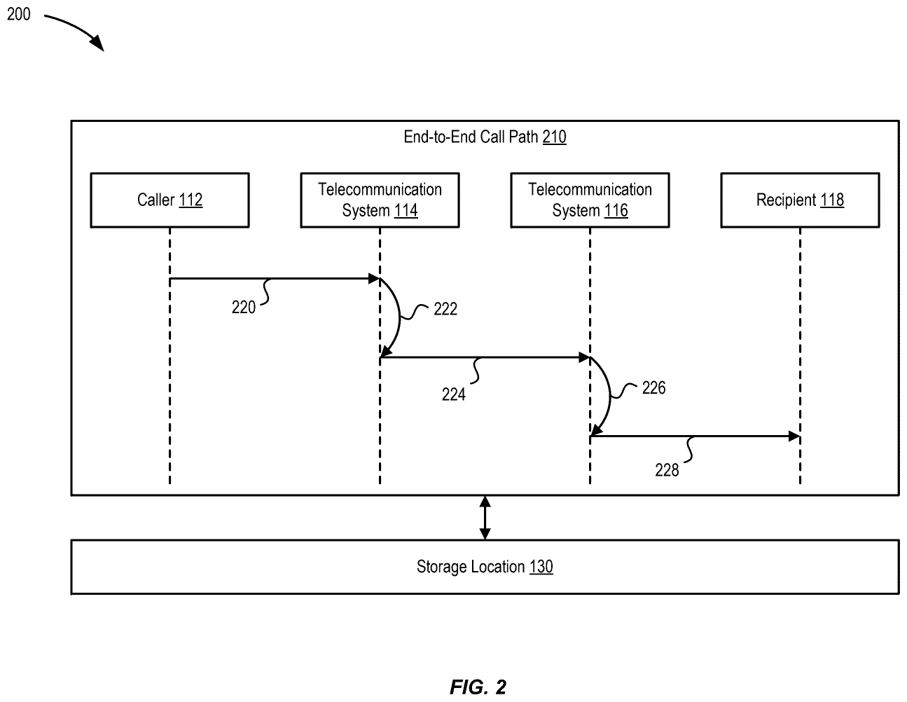

Turning now to FIG. 2, shown is flow diagram of an example of a process for intelligently verifying telephone calls using authenticated identity information according to some aspects. Details associated the caller, various telecommunication systems, recipient, and storage location are discussed above in relation to FIG. 1. The similar components illustrated in FIG. 2 may share the same description as the corresponding components described above in relation to FIG. 1, and as a result, the description below may reference the prior discussion of similar functionality.

The process 200 shown in FIG. 2 relates to placing a telephone call along the end-to-end call path 210. The process 200 can begin when a caller 112 initiates a telephone call. Initiating a telephone call can involve the caller forming a communication 220 that may be sent to telecommunication system 114, which in this situation serves as an originating telecommunication system. The communication 220 can include information about the telephone call that can be used to verify the identity of the caller 112. For example, the information can include a telephone number associated with the caller 112, a telephone number associated with the recipient 118, and a time that the telephone call was initiated. This information can be formed into a web token, such as a JSON web token. The web token can be added to a SIP method. For example, the web token can be added to a SIP header of the SIP method. SIP is a signaling protocol for initiating, maintaining, and terminating communication sessions between participants operating internet protocol (IP) devices. The SIP method is an invitation to a participant (e.g., recipient 118) to communicate with the sender of the SIP method (e.g., the caller 112). The SIP method can be used to enable VoIP.

In some examples, the web token can be a personal assertion token (PASSporT), which is a type of JSON web token that includes additional information about the caller 112 and is formatted having a header, a payload, and a cryptographic signature. The header of the PASSporT can define the type of PASSporT, the payload can include additional identity information about the telephone call, and the cryptographic signature comprises a signature for verifying the identity of the caller 112 using public and private key asymmetric cryptographic techniques (e.g., STIR/SHAKEN). In some examples, the web token can further include rich call data (RCD) associated with the caller 112. In these examples, the communication may be referred to as a Rich Call Data (RCD) Personal Assertion Token (PASSporT). RCD may include support for additional features of the call request such as a calling name of the caller 112, a short message explaining the reason for the telephone call, or a display of an image, such as a company logo, for example.

Also included in the communication 220 can be a reference to a security certificate. The reference may be a URI, such as a Uniform Resource Locator (URL) that is accessible by telecommunication system 114 or telecommunication system 116 for viewing and/or downloading the security certificate. The security certificate can include information, such as a public key associated with the caller 112, that the telecommunication systems 114, 116 can use to verify the identity of caller 112. In some examples, publishing of the public key in the security certificate may be accomplished through using the services of a commercial Certification Authority (CA) (not shown). The public key information published in security certificate can be used by digital signature verification software operating within telecommunication system 114 or telecommunication system 116 to verify digital signatures and prove authenticity of callers, such as caller 112. Successful verification of the digital signatures can provide proof that the telephone numbers associated with caller 112 and recipient 118 have not been tampered with in transit along the end-to-end call path 210. In addition to the public key information, the security certificate may include additional information about the caller 112 such as a country, organization, organization unit, distinguished name qualifier, state or province name, common name, serial number, locality, title, surname, given name, initials, pseudonyms, and/or generation qualifiers (e.g., “Jr.,” “3rd,” or “IV”) associated with the caller 112.

Also included in the security certificate can be an extension object identifier (OID) containing a reference, such as a Uniform Resource Namespace (URN), pointing to a document containing identity information about an entity and stored in storage location 130. In one example, the document may be a Verifiable Credential Decentralized Identifier (DID) document and the reference may be DID URN. The DID URN may refer to a location within a DID namespace where the verifiable credential DID document is located. Additionally, the DID URN may include other information used to process a DID method associated with the DID and the related DID document. For instance, a DID URN may have the form “did: example: 0123456789abcdefg” which identifies the URN as a DID method of type “example,” and an identity or service endpoint of “0123456789abcdefg.” In this case, the DID method “example” may describe how the identity or service endpoint would be processed (e.g., similar to how a function or procedure in a computer program defines the operation against the values passed to the function or procedure). In one example, the DID method “example” can involve returning some attributes or other information about the identity of “0123456789abcdefg.”

Continuing with FIG. 2, and as described above, storage location 130 can be configured to host, publish, store, or otherwise make available identity information about callers, such as caller 112. The identity information in the document provides additional information (e.g., in addition to the identity information in the SIP method and the security certificate) to telecommunication systems or recipients of telephone calls. As one example, the identity information can include a description of the caller, including details about the individual or the enterprise that is the holder of the telephone number. The description can include licensing or insurance information corresponding to the caller, for example. Furthermore, this identity information in the document can include the same public key as in the security certificate and can be verified by the respective telecommunication system using the same verification techniques.

The communication 220 can be received by telecommunication system 114. Once received, telecommunication system 114 can perform operations on the communication 220, denoted by processing arrow 222, to verify the identity information of the caller 112. The operations can involve accessing the various sources of identity information described above (e.g., the SIP method, the security certificate, and the document). For example, the security certificate may be a text file locatable via a key of the PASSporT, where the key is a URL. Telecommunication system 114 may dereference an IP address of the domain name of the server hosting the security certificate file and use the path in the URL to request the file itself using secure HTTP protocols (e.g., HTTPS). Once telecommunication system 114 determines the IP address and path of the file, the telecommunication system 114 can download the security certificate and process information about the authenticity of the file. This may include constructing a certificate file validation path and ensuring all of the digital signatures of the security certificates in the validation path are authentic, current, and valid. Once each source of identity information is evaluated, telecommunication system 114 can make a determination about the verifiability of the caller and then forward the communication 220, as represented by arrow 224, to the next telecommunication system in the chain, such as telecommunication system 116.

When telecommunication system 116 receives the communication 220 from telecommunication system 114, telecommunication system 116 may perform similar operations, denoted by processing arrow 226, to verify the identity information of the caller 112. For example, telecommunication system 116 may download the security certificate using the reference (e.g., the URL) contained in the SIP method. Telecommunication system 116 can also extract additional identity information from storage location 130 through the reference (e.g., the OID) to the document stored in storage location 130. In addition to accessing and extracting the identity information, telecommunication system 116 can authenticate the identity information contained in the storage location 130. This can involve confirming that the cryptographic signatures in the document and are verifiable using the same public key published in the security certificate. Successful verification of the digital signatures proves that the calling and called numbers have not been tampered with in transmit along the end-to-end call path 210.

In the case where telecommunication system 116 has verified the identity information about caller 112, telecommunication system 116 can transmit the telephone call via path 228 to recipient 118 with an indication that the caller 112 is verified. In addition to transmitting the telephone call, the telecommunication system 116 can include some or all of the identity information described above, such as the identity information extracted from the original communication 220, the identity information extracted from the security certificate, and/or the identity information extracted from the document stored in storage location 130, in the call transmission. This can provide recipient 118 with more information about the caller 112. In the case where telecommunication system 116 is unable to verify the identity information about caller 112, for example because the public key in the security certificate and/or the document is incorrect, the telecommunication system 116 can transmit, via path 228, the telephone call to recipient 118 with a label indicating that the caller 112 is not verified. When the recipient 118 receives the telephone call, the recipient can view (via their user device) the indication about verifiability and decide whether to answer the telephone call or decline it based on the provided verifiability indication. In other examples, when the telecommunication system 116 determines that the caller 112 is not verified, the telecommunication system 116 can block the telephone so that it is not sent to the recipient 118.

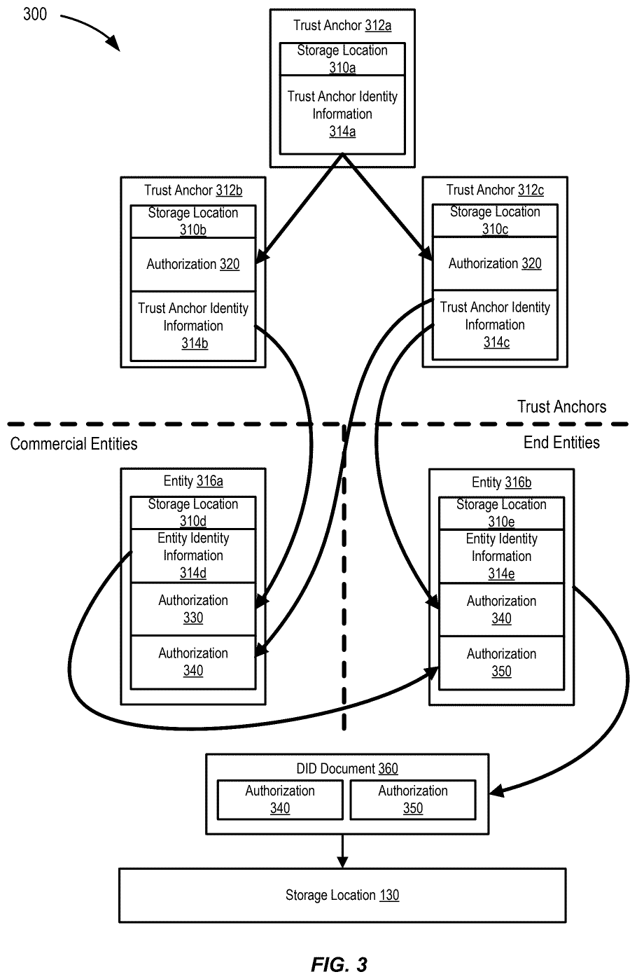

FIG. 3 is a block diagram of an example of a process 300 for issuing identity information according to some aspects. As illustrated in FIG. 3, process 300 includes multiple trust anchors 312a, 312b, and 312c and multiple end entities 316a and 316b. Process 300 illustrates the concept of a trust anchor using the private key associated with its own identity information to issue authorizations to subordinate trust anchors and subordinate end entities who store that authorization as part of their own identity information in their respective storage locations (e.g., storage locations 310a-c). The process 300 culminates with an end entity depositing copies of the authenticated identity information as a DID document 360 that can be stored in a storage location 130. As described above in relation to FIG. 1, storage location 130 can be any suitable storage location configured to store, publish, or otherwise make available identity information such as a blockchain (public or private), a registry (centralized or decentralized), or a data repository. In some examples, the storage location 130 can be referred to as a verifiable data registry (VDR). The DID document 360 created by process 300 is the object pointed to by the URN reference, which is in the DID OID extension of the security certificate, as described above in relation to FIG. 2.

Beginning at the top of process 300, trust anchor 312a may be configured to authenticate and issue authorizations to subordinate trust anchors 312b and 312c. In some examples, trust anchors 312a, 312b, and 312c can be governmental authorities. In some examples, trust anchors may be referred to as trusted third parties who may be responsible with issuing security certificates. Trust anchor 312a can authenticate and issue authorization 320 to each of trust anchor 312b and trust anchor 312c. When each of trust anchor 312b and 312c receives authorization 320 from trust anchor 312a, this authorization 320 authenticates the identity of each subordinate trust anchor and provides proof that each subordinate trust anchor can legally operate in the state, country, region associated with trust anchor 312a. Each of trust anchor 312b and 312c can store this authorization 320 in their respective storage location 310b and 310c.

Additionally, each trust anchor 312a, 312b, and 312c can store trust anchor identity information, 314b, and 314c in their respective storage locations 310a, 310b, and 310c. As described in relation to FIGS. 1 and 2, identity information can include descriptions of the respective trust anchor such as details about the trust anchor, contact information, licensing information, insurance information, hours of operation, and the like. Importantly, each trust anchor 312a, 312b, and 312c has the freedom to insert any details into their respective trust anchor identity information 314a, 314b, and 314c.

After trust anchor 312b and trust anchor 312c receive the appropriate authorizations, they each can issue authorizations to commercial or end entities, illustrated as entities 316a and 316b in process 300. For example, entity 316a can receive authorization 330 from trust anchor 312b and authorization 340 from trust anchor 312c. Additionally, entity 316b can receive authorization 340 from trust anchor 312c. Additionally, and similar to each trust anchor storing identity information in their respective storage locations, each entity 316a and 316b can store their own identity information 314d and 314e, respectively, in their respective storage locations 310d and 310e. Similar to above, entity identity information 314d and 314e can include additional details provided by entity 316a and entity 316b about their identity (e.g., addresses, contact information, hours of operation, purpose, etc.).

In one example, trust anchor 312a, which can be a State Secretary of State, can issue authorization 320 to trust anchor 312b, which can be a State Department of Insurance, and trust anchor 312c, which can be a State Department of Business Licenses. Authorization 320 authenticates the identity of trust anchors 312b and 312c and authorizes them to operate legally in the State. Continuing on, entity 316a can be a commercial entity representing an insurance enterprise. In some examples, commercial entities may also be a trusted third party, and other examples of commercial entities may include auditing firms or financial institutions. Trust anchor 312b can issue authorization 330 to entity 316a that authenticates the identity information associated with the insurance of entity 316a. Similarly, trust anchor 312c can issue authorization 340 to entity 316a that authenticates the identity information associated with a business license held by the entity 316a. Staying with the example, entity 316b can represent a business outsourcing organization. Entity 316b can receive authorization 340 from trust anchor 312c and authorization 350 from entity 316a. Authorization 340 can authenticate identity information associated with an insurance policy held by 316b and authorization 350 can authenticate a business license held by entity 316b, for example. Entity 316b can deposit copies of each authorization into a DID document 360. The DID document 360 can be stored, published, or otherwise made available in storage location 130 can be accessed, for example, by the telecommunications systems described above with respect to FIG. 2 when a telecommunication system is processing a call request to verify the identity of entity 316b when entity 316b places a call.

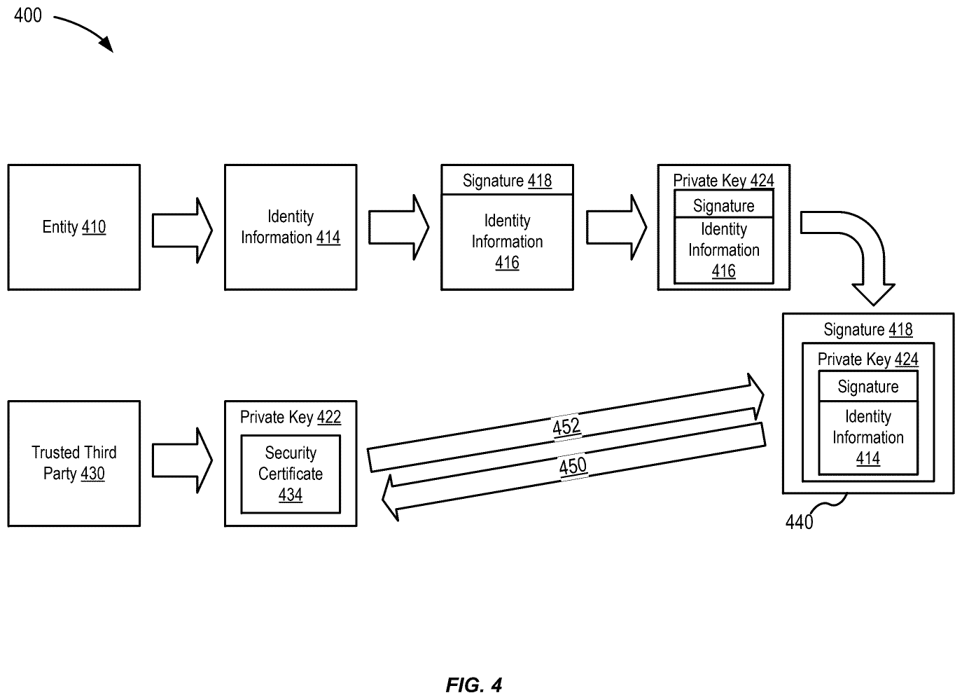

Turning now to FIG. 4, shown is a block diagram of an example of a process 400 for establishing an inter-PKI trust relationship for intelligently verifying telephone calls using authenticated identity information according to some aspects. As described above, conventional telephone call requests utilizing STIR/SHAKEN call authentication techniques verify callers by processing two primary sources of information. The first source is a shaken PASSporT, which is encoded in the SIP identity header of an SIP method. The process for encoding of the PASSporT can be described in the Internet Engineering Task Force (IETF) Secure Telephone Identity Revisited (STIR) request for comments (RFCs) and the Alliance for Telecommunication Industry Solutions (ATIS) standards. However, while the PASSporT is carried in a SIP “identity” header, there is no specific “identity” identifier within the PASSporT. Instead, the PASSporT may contain an “orig” key which may be populated with the calling number. There may also be an “origid” key which is specified to be an opaque identifier of local significance to the originating telecommunication service provider only. In some example telecommunication systems, the “origid” key is commonly recommended to be populated with a Universally Unique ID (UUID), which may be defined in the IETF STIR RFCs, for example.

The second source of information utilized in STIR/SHAKEN call authentication techniques to verify callers can be in the security certificate, which, as described above, can be referenced by a URL located in the SIP method. Verifying information in the security certificate can involve constructing a security certificate file validation path and ensuring that all the cryptographic signatures of the security certificates in the validation path are authentic, current, and valid. The structure of the security certificate in conventional PKIs can be defined by IETF RFCs. Security certificates can include identity information about the caller (county, organization, state, common name, etc.) but they still yield limited information about showing or proving who the caller really is.

In essence, conventional techniques utilizing SIP methods and security certificates provide little identity information about the caller identity. Improved identity information and trust attribute information about the caller can be obtained using the techniques described herein, for example by including additional identity information in external documents such as DID documents. In using such documents, though, there may be a desire for an inter-PKI method of sharing such documents and trust information in conventional PASSporTs and/or security certificates. To that end, FIG. 4 shows a process 400 for establishing an inter-PKI trust relationship for intelligently verifying telephone calls using authenticated identity information according to some aspects.

A PKI can refer to a system for creating, managing, storing, authenticating, and using security certificates utilizing public key encryption. Security certificates may be used in a PKI to authenticate and authorize secure communications using public/private key asymmetric cryptography. The process 400 illustrated by FIG. 4 shows an inter-PKI trust relationship between a conventional PKI based on security certificates and a PKI based on identity information issued in a document, such as a DID document. Each PKI illustrated by process 400 may utilize public/private key pairs and asymmetric cryptography.

The first PKI illustrated by FIG. 4 is represented as beginning with entity 410. The sequence of steps following entity 410, illustrated by the sequence arrows, can represent a PKI that authenticates entities using identity information issued in the form of an authenticated DID document 440. In the PKI beginning with entity 410, public/private key pairs are managed by the entity 410 and stored in entity “wallets.” A wallet can be a digital storage location owned and managed by entity 410. Additionally or alternatively, the identity information in the DID document may be stored in a separate storage location (e.g., storage location 130) configured to store, publish, or otherwise make available identity information. For example, the storage location can be a blockchain (public or private), a registry (centralized or decentralized), or a data repository. The separate storage location can be referred to as a VDR.

The second PKI illustrated by process 400 of FIG. 4 can be a conventional PKI based on security certificates that begins with trusted third party 430. Trusted third party 430 can be a secure telephone identity (STI) certification authority (CA) authorized to issue security certificates 434 to entities such as entity 410. As mentioned above, the security certificate can be referenced in a PASSporT included in the SIP method of a telephone call communication (e.g., communication 220). Included in the security certificate 434 is a signature by the trusted third party 430 signed using private key 422 verifying the identity of the holder of the security certificate (e.g., entity 410).

Referring back to entity 410, entity 410 can create their own identity information 414 (e.g., DID document) and cryptographically sign it with signature 418. Cryptographically signing identity information 414 can authenticate entity 410 as the holder of the identity information 414. In some examples, the self-signed aspect of the identity information 414 (e.g., an entity's DID document) can be a core concept known as Self-Sovereign Identity (SSI). SSI can be referred to as an approach to digital identity that enables entities to have control over the information they use to prove who they are to websites, services, and applications across the Internet. The format of the identity information 414 (e.g., DID document) can be determined by the entity itself (e.g., entity 410), and, similar to the security certificates, can contain cryptographic credentials such as a public key and a cryptographic signature (e.g., signature 418). The DID documents can be written using JSON, XML, or another declarative language.

To generate the identity information 414, the entity 410 can execute a sequence of processing steps of applying signatures and private key signatures to the identity information 414. After entity 410 generates identity information 414 and applies their cryptographic signature 418 to it, the identity information 414 is cryptographically counter-signed using private keys (e.g., private key 424) associated with identity information of issuer authorities. The issuer authorities can be the same as the trust anchors described in relation to FIG. 3. After the issuer authorities have properly issued authorizations and cryptographically signed the identity information 414 associated with entity 410, entity 410 can once again apply their cryptographic signature 418. At this point in process 400, the identity information 414 is authenticated identity information that can be stored in a document 440, which can be referred to as an authenticated DID document 440. Authenticated DID document 440 may then be stored in a digital wallet of entity 410 or stored in a separate storage location, as described above.

The authenticated identity information in the document 440 and the security certificate 434 can include references to each other for use by telecommunication systems for verification and authentication purposes. As such, the security certificate 434 can include an extension, such as an OID extension, with a reference 452 pointing to the document 440 held by entity 410. Additionally, the document 440 can include a reference 450 (e.g., a URL) pointing to the security certificate 434. In some examples, a repository can store security certificates and the reference 450 can point to this repository.

As described earlier, relying parties such as telecommunication systems can download and verify the security certificate 434 associated with a telephone call. Using the reference 452, the relying parties can access the document 440 and verify the authenticity of the trust attribution authorization claims contained within it (e.g., authorizations issued by trust anchors), thereby establishing the inter-PKI trust relationship.

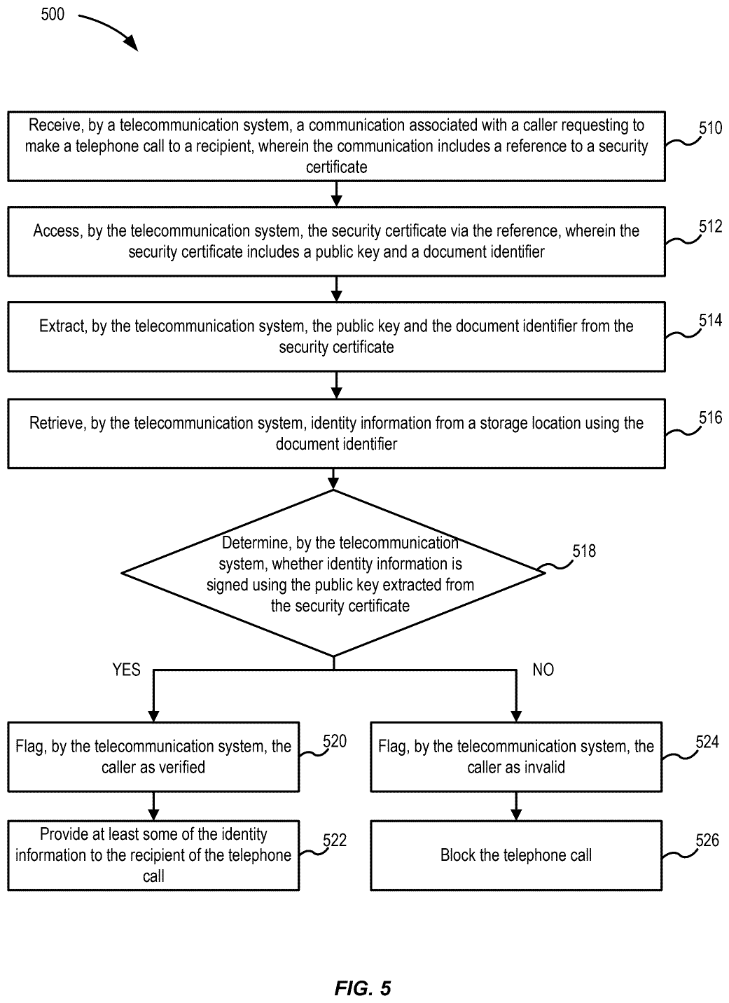

FIG. 5 is a flowchart of an example of a process 500 for intelligently verifying telephone calls using authenticated identity information according to some aspects. Other examples may include more operations, fewer operations, different operations, or a different order of operations than is shown in FIG. 5. For example, the process 500 may be modified in other examples to skip a step (e.g., skip block 522) or repeat steps. Steps may be iterated as necessary to achieve the benefits of the techniques described herein.

The steps illustrated by process 500 may be performed by one or more processors, which can be part of a telecommunication system or another system. For the sake of simplicity, the steps illustrated in process 500 are described below in relation to being performed by a processor, although variations and other configurations are possible.

The process 500 may begin at block 510 in which a telecommunication system can receive a communication associated with a caller requesting to make a telephone call to a recipient. The communication received by the telecommunication system can include a reference to a security certificate. Details associated with the communication, the security certificate, the inter-PKI trust relationship, the authenticated identity information, etc. are discussed above in relation to FIGS. 1-4. The communication can include information about the telephone call that can be used to verify the identity of the caller (e.g., telephone number associated with the caller, a telephone number associated with the recipient, and a time that the telephone call was initiated) that can be formed into a JSON web token and added to a SIP header of a SIP method.

At block 512, the telecommunication system can access the security certificate via the reference. Accessing the security certificate can involve downloading the security certificate using the URI. The telecommunication system can then process information about the authenticity of the security certificate. This may include constructing a certificate file validation path and ensuring all of the digital signatures of the security certificates in the validation path are authentic, current, and valid. Successful verification of the digital signatures may help to prove that the security certificate is authentic.

The security certificate can comprise a public key and a document identifier. The public key can correspond to an asymmetric key pair of the caller. The document identifier can comprise a URI, such as a URN or URL, from which a document with additional identity information can be obtained.

At block 514, the telecommunication system can extract the public key and the document identifier from the security certificate. As described above, the document identifier can be a URN, which may refer to a unique identifier that points to a namespace or resource stored on the Internet. If the document identifier is a URN, the telecommunication system may dereference an IP address of a domain name of a server hosting the identity information referenced by the URN. One common example of a namespace deference process can be a Domain Name Service (DNS) client using DNS protocol to dereference a domain name to discover the IP addresses associated with the URN.

At block 516, the telecommunication system can retrieve identity information from a storage location using the document identifier. For example, the telecommunication system can download the document corresponding to the document identifier and extract the identity information from said document.

At block 518, the telecommunication system can determine whether identity information is signed using the public key extracted from the security certificate. In other words, the telecommunication can verify that the identity information and the security certificate are associated with (e.g., issued, maintained, owned, or operated) by the same entity. As described above in relation to FIG. 4, this can include verifying that the cryptographic signatures on the identity information and the security certificate are signed using the same public key signatures. The processing steps illustrated by FIG. 4 and block 518 establish the inter-PKI trust relationship between a PKI based on conventional security certificates and PKI based on authenticated identity information (e.g., DID documents).

As illustrated by FIG. 5, a decision tree follows block 518. In the case where the telecommunication system verifies that the identity information stored in the storage location is signed using the same public key extracted from the security certificate, process 500 flows along the “YES” branch to block 520, where the telecommunication system flags the caller as verified. Additionally, and according to some examples, after the caller is flagged as verified in block 520, the telecommunication system may allow the call to be transmitted to the recipient. At block 522, the telecommunication system can provide at least some of the identity information to the recipient of the telephone call. The identity information can then be displayed on a user device (e.g., mobile device, monitor, computer screen, etc.) associated with the recipient to provide the recipient with more information about the telephone call.

In the case where the telecommunication system is unable to verify the identity information (e.g., the identify information is not signed using the public key extracted from the security certificate), then process 500 flows along the “NO” branch to block 524, where the telecommunication system flags the caller as invalid (e.g., not verified). If the caller is flagged as invalid, in some examples the telecommunication system may still transmit the telephone call to the recipient, it may just transmit the call with an indication that the telephone call is from an invalid caller, at which point the recipient can decide to answer/decline the telephone call. Alternatively, the telecommunication system can block the telephone call altogether, as shown in block 526, so that it is not transmitted to the recipient. The determination of the telecommunication to either provide some of the identity information (e.g., in the case where the caller is verified) or block the telephone call (e.g., in the case where the caller is not verified) can be based on a pre-determined preference set by the recipient. For example, the recipient can decide that all telephone calls that are not verified should be blocked. As another example, the recipient can decide that for every caller that is verified, certain identity information (e.g., a business logo) should be included in the telephone call.

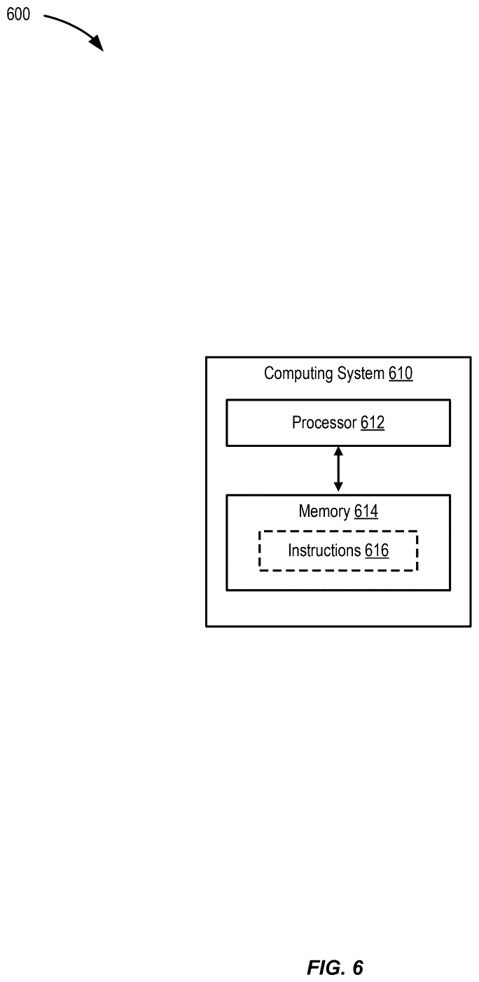

FIG. 6 is a block diagram of an example of a computing system 610 usable to implement some aspects described herein. The computing system 610 includes a processor 612 communicatively coupled with a memory device 614. The processor 612 can include one processor or multiple processors. Non-limiting examples of the processor 612 include a Field-Programmable Gate Array (FPGA), an application-specific integrated circuit (ASIC), or a microprocessor. The processor 612 can execute instructions 616 stored in the memory device 614 to perform operations. In some examples, the instructions 616 can include processor-specific instructions generated by a compiler or an interpreter from code written in any suitable computer-programming language, such as C, C++, C#, etc. For example, the instructions 616 can include the instructions that cause the processor 612 to perform the operations discussed in relation to process 500 of FIG. 5.

The memory device 614 can include one memory device or multiple memory devices. The memory device 614 can be non-volatile and may include any type of memory device that retains stored information when powered off. Non-limiting examples of the memory device 614 include electrically erasable and programmable read-only memory (EEPROM) or flash memory. At least some of the memory device includes a non-transitory computer-readable medium from which the processor 612 can read instructions 616. A computer-readable medium can include electronic, optical, magnetic, or other storage devices capable of providing the processor 612 with computer-readable instructions 616 or other program code. Non-limiting examples of a computer-readable medium include magnetic disk(s), memory chip(s), ROM, random-access memory (RAM), an ASIC, a configured processing device, optical storage, or any other medium from which a computer processing device can read the instructions 616.

The forgoing examples are not limited to the precise number and arrangement of telecommunication service providers, computing devices, components, and/or steps described above. Other examples can involve other combinations or arrangement of these elements. Numerous other modifications, adaptations and uses of the techniques described herein will be apparent to those skilled in the art without departing from the scope of the disclosure.

1. A method comprising:
receiving, by a telecommunication system, a communication associated with a caller requesting to make a telephone call to a recipient, wherein the communication includes a reference to a security certificate;
accessing, by the telecommunication system, the security certificate via the reference, wherein the security certificate includes a public key and a document identifier;
retrieving, by the telecommunication system, identity information from a storage location using the document identifier; and
in response to verifying the identity information using the public key, flagging, by the telecommunication system, the caller as verified.

2. The method of claim 1, wherein the communication is a Session Initiation Protocol (SIP) invite, the SIP invite comprises a JavaScript Object Notation (JSON) web token, the JSON web token includes the reference to the security certificate, the reference comprises a Uniform Resource Locator (URL), and the document identifier comprises a Uniform Resource Name (URN).

3. The method of claim 1, wherein the storage location is a blockchain.

4. The method of claim 1, further comprising:
in response to a verification process failing for the identity information, flagging, by the telecommunication system, the caller as not verified.

5. The method of claim 4, further comprising:
in response to flagging the caller as not verified, blocking the telephone call.

6. The method of claim 1, wherein the identity information includes at least a description of the caller and a reason for calling.

7. The method of claim 1, wherein the identity information is issued by at least one trust anchor entity and is stored in the storage location as a decentralized identifier document.

8. A telecommunication system comprising:
one or more processors; and
one or more memories including instructions executable by the one or more processors to cause the one or more processors to:
receive a communication associated with a caller requesting to make a telephone call to a recipient, wherein the communication includes a reference to a security certificate;
access the security certificate via the reference, wherein the security certificate includes a public key and a document identifier;
retrieve identity information from a storage location using the document identifier; and
in response to verifying the identity information using the public key, flag the caller as verified.

9. The telecommunication system of claim 8, wherein the communication is a Session Initiation Protocol (SIP) invite, the SIP invite comprises a JavaScript Object Notation (JSON) web token, the JSON web token includes the reference to the security certificate, the reference comprises a Uniform Resource Locator (URL), and the document identifier comprises a Uniform Resource Name (URN).

10. The telecommunication system of claim 8, wherein the storage location is a blockchain.

11. The telecommunication system of claim 8, wherein the instructions are further executable by the one or more processors to cause the one or more processors to:
in response to a verification process failing for the identity information, flag the caller as not verified.

12. The telecommunication system of claim 11, wherein the instructions are further executable by the one or more processors to cause the one or more processors to:
in response to flagging the caller as not verified, block the telephone call.

13. The telecommunication system of claim 8, wherein the identity information includes at least a description of the caller and a reason for calling.

14. The telecommunication system of claim 8, wherein the identity information is issued by at least one trust anchor entity and is stored in the storage location as a decentralized identifier document.

15. A non-transitory computer-readable medium comprising program code that is executable by a processor to cause the processor to:
receive a communication associated with a caller requesting to make a telephone call to a recipient, wherein the communication includes a reference to a security certificate;
access the security certificate via the reference, wherein the security certificate includes a public key and a document identifier;
retrieve identity information from a storage location using the document identifier; and
in response to verifying the identity information using the public key, flag the caller as verified.

16. The non-transitory computer-readable medium of claim 15, wherein the storage location is a blockchain.

17. The non-transitory computer-readable medium of claim 15, further comprising program code that is executable by the processor to cause the processor to:
in response to a verification process failing for the identity information, flag the caller as not verified.

18. The non-transitory computer-readable medium of claim 17, further comprising program code that is executable by the processor to cause the processor to:
in response to flagging the caller as not verified, block the telephone call.

19. The non-transitory computer-readable medium of claim 15, further comprising program code that is executable by the processor to cause the processor to:
in response to the caller being flagged as valid, provide at least some of the identity information to the recipient of the telephone call, wherein the identity information includes at least a description of the caller and a reason for calling.

20. The non-transitory computer-readable medium of claim 15, wherein the identity information is issued by at least one trust anchor entity and is stored in the storage location as a decentralized identifier document.
